(19) United States
(12) Patent Application Publication
(10) Pub. No.: US 2007/0255475 A1
(43) Pub. Date: Nov. 1, 2007

(54) METHOD AND ARRANGEMENT FOR CONTROLLING BRAKES IN A VEHICLE OR A VEHICLE COMBINATION

(75) Inventors: Ingemar Dagh, Goteborg (SE); Niklas Frojd, Molnlycke (SE); Bjorn Antonsson, Hisings-Karra (SE)

Correspondence Address: NOVAK DRUCE & QUIGG, LLP, 1300 EYE STREET NW, SUITE 1000 WEST TOWER, WASHINGTON, DC, 20005, US

(73) Assignee: VOLVO LASTVAGNAR AB, Goteborg (SE)

(21) Appl. No.: 11/164,958

(22) Filed: Dec. 12, 2005

Related U.S. Application Data
(63) Continuation of application No. PCT/SE04/00430, filed on Mar. 23, 2004.

(30) Foreign Application Priority Data
Jun. 12, 2003 (SE) 0301708-4

(51) Int. Cl. B60T 8/20

(52) U.S. Cl. 701/71; 303/148

(57) ABSTRACT

Method and an arrangement for controlling the driving brakes of a vehicle or a vehicle combination with at least two wheel axles, each axle having two or more wheels with tires. The arrangement includes a control unit (1, 21) for controlling the brakes and a signal generator for generating a signal proportional to the air pressure in one or several tires. The control unit (1, 21) is arranged, upon the reception of the signal, to detect an abnormal drop in pressure and to reduce the braking function for all the braking devices (6, 7; 8, 9; 26, 27; 28, 29) on the axle (10, 11; 30, 31) on which an abnormal drop in pressure has been detected in any one tire.

### CROSS-REFERENCE TO RELATED APPLICATIONS:

The present application is a continuation patent application of International Application No. PCT/SE2004/000430 filed 23 Mar. 2004 which is published in English pursuant to Article 21(2) of the Patent Cooperation Treaty, and which claims priority to Swedish Application No. 0301708-4 filed 12 Jun. 2003. Said applications are expressly incorporated herein by reference in their entireties.

### TECHNICAL FIELD OF THE INVENTION

The invention relates to a method and an arrangement that allows a vehicle or a vehicle combination to be braked and brought to a standstill as quickly as possible, without an uneven distribution of braking forces if there is drop in pressure in one or several of the vehicle's tires.

### BACKGROUND OF THE INVENTION

When a tire of a car or lorry is subjected to a sudden drop in pressure, many drivers will immediately try to brake the vehicle in order to reduce the speed and bring the vehicle to a stop as quickly as possible. The drop in pressure can be caused by a puncture or a tire bursting with a subsequent rapid loss of pressure.

If no preventative measures are taken, the axle on which the punctured tire is mounted will have an uneven distribution of braking forces between the wheels on that axle. This uneven distribution can cause a vehicle or a vehicle combination to swerve and bring about an uncontrollable situation for the driver. In the worst case, such a situation can lead to the vehicle going off the road, overturning, jack-knifing, where the vehicle combination “pivots” around the connection between the tractor and trailer, and/or colliding with other vehicles.

U.S. Pat. No. 5,696,681 has, for example, described previously how, in the event of a puncture, the vehicles and brakes can be controlled selectively in order to control the path of the vehicle. By comparing the vehicle's required path with its actual path and controlling the braking forces selectively, a control braking can be achieved. The problem with this solution is that it is not taken into account which axle the punctured tire is mounted on when regulating the braking forces. The solution also requires a large number of components, which increases both the cost and the number of possible sources of error.

U.S. Pat. No. 5,934,768 has described previously a redistribution of the vehicle's braking forces when a puncture is detected. According to a preferred embodiment, this is carried out by the wheel on the opposite side having a heavier braking force applied. The problem with this solution is that a braking force redistributed in this way causes an increased swerving moment, which in turn can lead to increased instability when braking.

The abovementioned problems can be solved by the method according to the invention, in which the braking forces that are allocated to the axle that comprises a punctured tire are reduced. The solution according to the invention thereby prevents the driver being taken by surprise by a strong swerving moment when braking.

### SUMMARY OF THE INVENTION

An object of the invention is therefore to achieve a method that allows a vehicle or a vehicle combination to be braked and brought to a stop as quickly as possible, without uneven distribution of braking forces, if there is a drop in pressure in a tire on the vehicle, and an arrangement for carrying out the method according to the invention. This solution is described in the characterizing part of claim 1 relating to the method and of claim 8 relating to the arrangement.

The invention relates firstly to a method for controlling the brakes of a vehicle or a vehicle combination comprising at least two wheel axles, each axle having two or more wheels with tires. In the following text, the expression “vehicle” will be used for both tractors and semi-trailers and vehicle combinations comprising trailers. The invention can be applied to both single and dual wheels, and to so-called “super single” wheels. The latter consists of a wide single wheel intended to replace a dual wheel.

The method according to a preferred embodiment of the invention comprises the following steps: generating a signal related to the air pressure in one or several tires, which signal is sent to a control unit in the vehicle; detecting an abnormal drop in pressure in one or several tires; and reducing the braking function for all the braking devices on the axle on which a drop in pressure has been detected in any one tire.

In this connection, the term reduction of the braking force or the braking function means that the braking force can be reduced or disconnected completely or partially, or can possibly be delayed in relation to the driver's application of the brakes. The extent of the reduction can depend on the circumstances such as the vehicle's momentary speed or load and is determined by the control unit.

The signal can be generated by one or several different sensors, which will be described below. The monitoring of the pressure of the tires can be carried out continually, with the control unit determining when a fault arises.

Alternatively, the generation of the signal can be carried out when the pressure of the tire drops below a predetermined value, for example in the event of a slow puncture, or when the drop in pressure per unit of time exceeds a predetermined value, for example in the event of a rapid occurrence such as a tire bursting.

According to an embodiment, the braking function for the remaining braking devices can be controlled to compensate for the loss of braking function on one or several axles, when a drop in pressure is detected in a tire and the braking function is disconnected from the associated axle. This redistribution of braking forces to the vehicle's other axles should be carried out as soon as an error signal has been detected by the control unit.

According to another embodiment, the control unit selects a control program for regulating the braking devices taking into account which axle was disconnected.

According to an embodiment, the braking function can be restored gradually, possibly with a delay, to the respective disconnected braking devices. In the event of restoration, the control unit should restore the braking function gradually over a predetermined period of time, in order to give the driver time to be able to compensate for the swerving moment by turning the steering wheel during the braking. Also in this case, the restoration of the braking force to the disconnected axle should be able to be stopped, both by the control unit and by the driver.

According to an additional preferred embodiment, the invention relates to an arrangement for controlling the driving brakes of a vehicle or a vehicle combination comprising at least two wheel axles, each axle having two or more wheels with tires. The arrangement comprises a control unit for controlling the brakes and means for generating a signal in proportion to the air pressure in one or several tires. Upon the reception of the said signal, the control unit is arranged to detect an abnormal drop in pressure and to reduce the braking function for all the braking devices on the axle on which an abnormal drop in pressure has been detected in any one tire.

According to an embodiment, the control unit can be provided with a number of control programs for regulating the braking devices and is arranged to select a control program taking into account on which axle the drop in pressure has been detected. The selection of control program is determined by the control unit in response to whether the drop in pressure has been detected on a front axle with steerable wheels, a driving rear axle, a free-running axle or on an axle belonging to a trailer or a semi-trailer. In addition, there must be control programs for combinations of cases when a drop in pressure is detected for several tires located on the same or different axles.

The control unit can thereby control the vehicle's other braking devices in such a way that a retardation requested by the driver is compensated for the loss of braking function on one or several axles.

Depending upon the situation that has arisen, the control unit can weight the braking force individually for each wheel by means of the selected control program. By this means, a rapid braking can be achieved by utilizing the available braking force maximally for each wheel. This braking strategy can comprise all or certain of the axles in the vehicle or vehicle combination.

According to an embodiment described above, the control unit can also be arranged to restore the braking function to the disconnected braking devices gradually after a first predetermined period of time. The braking function for one or several disconnected axles can be restored slowly during a second predetermined period of time in order to give the driver time to compensate for any swerving moment by turning the steering wheel.

Detection of a drop in pressure in one or several tires can be achieved by a plurality of different sensors. The sensors can consist of a single type of sensor mounted in association with each tire that is to be monitored, or alternatively can consist of a combination of two or more types of sensor that measure different parameters.

According to an embodiment, said means for detecting a drop in pressure can consist of a pressure sensor, with the control unit being arranged to reduce the braking function for the associated axle when the pressure of the tire drops below a predetermined value. The reduction can carried out directly after an indication from the pressure sensor, or in combination with an additional indication from one or several alternative sensors. Pressure sensors can preferably be connected to each tire which is to be monitored by a common pressure monitoring system (TPM). The pressure sensor can consist of a pressure-detecting element that emits an intermittent or continual pressure signal, or a pressure switch that emits a signal in the event of a particular pressure.

In the case where the signal related to the air pressure is generated by an air pressure sensor, a continual signal is preferably used for monitoring the respective tire.

If detection of the signal is carried out after a first indication from an air pressure sensor and a second indication from at least one additional sensor related to the air pressure in one or several tires, a continual signal from the pressure sensor is preferably used, with an additional measurement of a second signal being carried out after an indication of a drop in pressure.

Detection of the signal can also be carried out after a first indication from at least one sensor related to the air pressure in one or several tires, and a second indication from an air pressure sensor. In this case, the signal from one or several of the additional alternative sensors is preferably continual.

The pressure signal can be either continual or intermittent. If the pressure signal is intermittent, a measurement of the pressure can be carried out immediately after an indication from an alternative sensor.

According to an additional embodiment, said means for detecting a drop in pressure can consist of wheel speed sensors. The signal from the sensor can give an indication to the control unit to reduce the braking function when a transient is detected in the wheel speed signal. The signals for wheel speed can be monitored by separate sensors or via an existing electronic braking system (EBS), which among other things can comprise anti-locking brakes (ABS) and traction control functions (TCS). Such a speed sensor can, for example, consist of a Hall sensor.

According to an additional embodiment, said means for detecting a drop in pressure can comprise level sensors in the vehicle's hydraulic suspension. The signal from the sensor can give an indication to the control unit to reduce the braking function when an inclination in the transverse direction of the vehicle indicated by the level sensors exceeds a predetermined value, or if a sudden inclination between the chassis and an axle is detected.

According to an additional embodiment, said means for detecting a drop in pressure can consist of pressure sensors in the vehicle's hydraulic suspension, with the control unit being arranged to reduce the braking function when an inclination in the transverse direction of the vehicle indicated by the pressure sensors exceeds a predetermined value, or if a sudden inclination between the chassis and an axle is detected. Examples of such sensors have been described above. In both these cases, the control unit must be arranged to be able to distinguish between an inclination caused by a drop in pressure in one or several tires and an inclination caused by the vehicle's load, the camber of the road surface, side winds or like.

According to an additional embodiment, said means for detecting a drop in pressure can comprise a swerve speed sensor mounted on the vehicle's chassis for detecting swerve speed. The signal from the sensor can give an indication to the control unit to reduce the braking function when the swerve speed suddenly exceeds a predetermined value. The swerve speed sensor can consist of a gyro sensor.

According to an additional embodiment, said means for detecting a drop in pressure can comprise an acceleration sensor mounted on the vehicles chassis to detect lateral acceleration. The signal from the sensor can give an indication to the control unit to reduce the braking function when the lateral acceleration suddenly exceeds a predetermined value. Such a sensor can consist of a conventional acceleration sensor.

According to an additional embodiment, said means for detecting a drop in pressure in a tire on any axle can comprise a microphone placed in or in association with the axle. A tire bursting on an axle generates a characteristic and often very loud noise which can be up to 130 dB. If the control unit records an output signal from the microphone corresponding to such a noise, or if the output signal suddenly exceeds a predetermined value, this constitutes a clear indication to the control unit that reduction of the braking function on the axle may be required.

Of the sensors and combinations of sensors described above, pressure sensors are preferable as they provide an immediate indication of the condition of each tire. In order to provide greater reliability and speed in association with monitoring tires and generating signals, several different sensor combinations can also be used, for example wheel speed sensors and level sensors. If the control unit is provided with an intermittent pressure signal, an indication of a drop in pressure from one or several other sensors can mean that the control unit immediately registers a new measurement value for pressure. If the control unit is provided with a continual pressure signal, an indication of a drop in pressure from one pressure sensor can be verified by an indication of the drop in pressure from one or several other sensors. When it has been confirmed that a drop in pressure has taken place and where this has taken place, the braking function on the axle or axles concerned can be reduced.

In all the examples described above, the control unit concerned carries out suitable remedial measures in the event of a sudden deviation in one or several input signals from certain predetermined sensors. The term “sudden” relates here to changes in the signals representing pressure, acceleration, noise level or the like which exceed normal fluctuations in the respective signals in normal operation. The control unit can suitably be calibrated for this, so that it only reacts to signals that are greater than or less than a predetermined level for a predetermined period of time, or that are changed by a certain amount per unit of time. Thus what is meant by the term “sudden” can vary in both size and time depending upon which parameters are being measured.

The advantage of the invention described above is that the braking function on the axle or axles where a puncture or the like has occurred can quickly be reduced completely or partially. The occurrence of an uneven distribution of braking forces between different wheels and axles is thus avoided, which braking force can cause the vehicle to swerve. At the same time, an immediate redistribution of the braking forces to other wheels can be achieved, which increases the driver's ability to handle the situation in a safe way.

### BRIEF DESCRIPTION OF THE DRAWINGS

The invention will be described in greater detail in the following, with reference to embodiments that are shown in the attached drawings, in which:

FIG. 1 is a schematic diagram that shows sensors for a first embodiment according to the invention; and

FIG. 2 is a schematic diagram that shows sensors for a second embodiment according to the invention.

### DETAILED DESCRIPTION

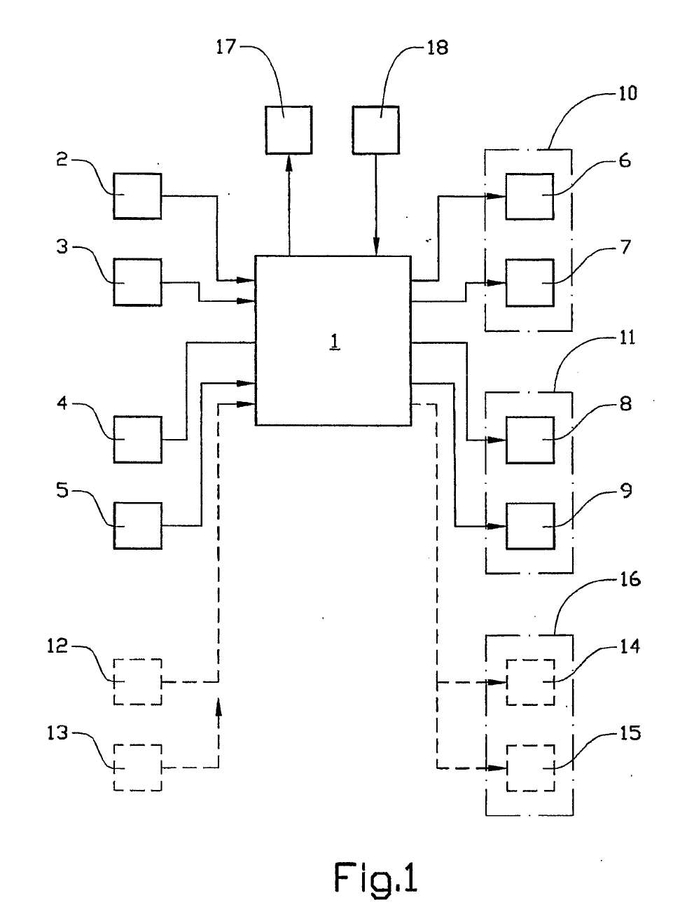

FIG. 1 shows a schematic diagram for an embodiment according to the invention comprising a vehicle provided with pressure sensors for monitoring a drop in pressure in one or several tires. This embodiment consists of a central control unit 1 for controlling the vehicle's driving brakes and means for generating a signal proportion to the air pressure in one or several tires. The control unit 1 is arranged to receive signals from a number of pressure sensors 2, 3, 4, 5, which measure the current air pressure in a corresponding number of tires. In response to these input signals, the control unit 1 sends output signals to a number of brake actuators 6, 7, 8, 9, which control the braking force to the respective wheels (not shown). Both the pressure sensors and the brake actuators are arranged in pairs on a number of axles 10, 11. Thus a first pair of pressure sensors 2, 3 is arranged to monitor the wheels on a first wheel axle 10 with braking devices that are controlled by a first pair of brake actuators 6, 7. In a corresponding way, a second pair of pressure sensors 4, 5 is arranged to monitor the wheels on a second wheel axle 11 with braking devices that are controlled by a second pair of brake actuators 8, 9.

For this embodiment, only a vehicle with two wheel axles will be described. The figure illustrates, however, that the control unit can be connected to additional sensors 12, 13 and brake actuators 14, 15 on several axles 16. All the axles comprised in the vehicle are suitably provided with sensors connected to the control unit.

The control unit 1 is arranged, upon the reception of said signal, to detect whether an abnormal drop in pressure has occurred in any one of the monitored tires. If such a drop in pressure is detected, the control unit 1 reduces the braking function for all the brake actuators on the axle on which an abnormal drop in pressure has been detected in any one tire. If this occurs, the driver is warned by a signal being sent to a warning unit 17 in the driver's cab. When the driver brakes the vehicle by activating a brake pedal 18, the control unit will redistribute the braking forces to the brake actuators on the vehicle's other axles. How this distribution is carried out depends on which braking strategy the control unit has selected, which selection depends in turn upon which wheel has a puncture. The control unit 1 is therefore pre-programmed with a number of different braking strategies, depending upon whether the puncture occurred in a tire belonging to an axle with steering front wheels, driving rear wheels, load-carrying rear wheels, or wheels belonging to a semi-trailer or a trailer. A selected braking strategy also takes into account whether the puncture occurred on the right or left side. The control unit constitutes a part of the vehicle's electronic braking system (EBS) and controls the braking in a conventional way in order to prevent any wheel locking or the vehicle swerving in any direction.

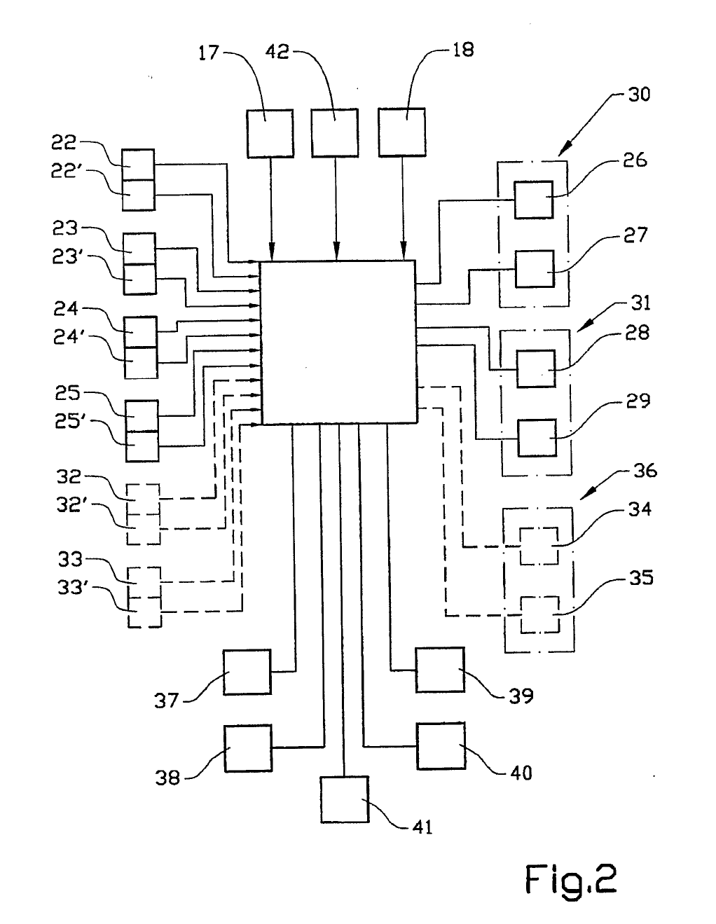

FIG. 2 shows a schematic diagram for an alternative embodiment according to the invention, comprising a vehicle corresponding to the one described in FIG. 1. As in FIG. 1, there is a warning unit 17 and brake pedal 18 in the driver's cab. The vehicle is provided with a plurality of sensors 22, 23, 24, 25 for monitoring a drop in pressure in one or several tires.

This embodiment consists of a central control unit 21 for controlling the vehicle's driving brakes and means for generating a signal proportional to the air pressure in one or several tires. The control unit 21 is arranged to receive signals from a number of speed sensors 22′, 23′, 24′, 25′, which measure the current speed of a corresponding number of wheels. In response to these input signals, the control unit 21 sends output signals to a number of brake actuators 26, 27, 28,29, which control the braking force to the respective wheels (not shown). Both the speed sensors and the brake actuators are arranged in pairs on a number of axles 30, 31. Thus a first pair of speed sensors 22′, 23′ is arranged to monitor the wheels on a first wheel axle 30 with braking devices that are controlled by a first pair of brake actuators 26, 27. In a corresponding way, a second pair of speed sensors 24′, 25′ is arranged to monitor the wheels on a second wheel axle 31 with braking devices that are controlled by a second pair of brake actuators 28, 29.

In the same way as FIG. 1, FIG. 2 illustrates that the control unit can be connected to additional pressure sensors 32, 33 and brake actuators 34, 35 on additional axles 36. All the axles comprised in the vehicle are suitably provided with pressure sensors and additional sensors, such as for example speed sensors 32′, 33′, connected to the control unit 21.

By comparing the wheel speed of wheels mounted on the same axle, the control unit 21 can detect whether an abnormal drop in pressure has occurred in any one of the monitored tires. When a puncture has arisen, the punctured wheel will cause a transient in the signal from the sensor concerned, which transient is not present in the signal from the sensor for the wheel that is mounted on the opposite end of the axle. If the pressure sensors have detected a drop in pressure in a tire on the same axle, the control unit determines that a puncture has occurred. The control unit 21 is arranged to reduce the braking function for all the brake actuators on the axle on which an abnormal drop in pressure has been detected in any one tire. The braking regulation can thereafter be carried out in same way as described for FIG. 1 above.

In order to avoid the control unit disconnecting the braking devices on an axle in the event of a sensor fault, several different existing sensors can be utilized as described above. The control unit 21 can also receive signals from existing pressure sensors 22, 23, 24, 25 or level sensors 37, 38, 39, 40 placed in association with the vehicle's hydraulic suspension. If one of these level sensors indicates that one corner of the vehicle, or the trailer or semi-trailer, has suddenly gone down, this is an indication that there has been a drop in pressure in the associated tire. If the pressure sensors have detected a drop in pressure in a tire on the same axle, the control unit determines that the puncture has occurred. The control unit can thereafter reduce the braking function for the axle on which the punctured tire is mounted.

The control unit 21 can also receive signals from one or several existing sensors for lateral acceleration. Note that the same reference numeral has been used for both the acceleration sensor and the swerve speed sensor. According to an embodiment, the control unit 21 is connected to an acceleration sensor 41 for detecting lateral acceleration. Thus the control unit 21 is arranged to detect whether the lateral acceleration for the wheel in question suddenly exceeds a predetermined value. Using measurement values from one or more acceleration sensors, the control unit can determine which tire has been punctured. If the pressure sensors have detected a drop in pressure in a tire on the same axle, the control unit determines that a puncture has occurred. The control unit can thereafter reduce the braking function for the axle on which the punctured tire is mounted.

In a corresponding way, the control unit 21 can detect if the swerve speed suddenly exceeds a predetermined value. Signals from one or more sensors detecting swerve speed 41 enable the control unit 21 to determine which tire has been punctured. If the pressure sensors have detected a drop in pressure in a tire on the same axle, the control unit determines that a puncture has occurred. The control unit can thereafter reduce the braking function for the axle on which the punctured tire is mounted. The swerve speed sensor consists of a gyro sensor.

The invention is not to be regarded as being limited to the embodiments described above, a number of additional variants and modifications being possible within the framework of the following patent claims.

What is claimed is:

1. A method for controlling the brakes of a vehicle or a vehicle combination comprising at least two wheel axles and each axle having two or more wheels with tires, said method comprising:
generating a signal related to the air pressure in at least one of the tires on the vehicle and said signal being sent to a control unit in the vehicle;
detecting an abnormal drop in pressure in at least one of the tires based on said generated signal; and
reducing the braking function produced by braking devices associated with the axle on which the tire is mounted that has been detected as experiencing an abnormal pressure drop.

2. The method as recited in claim 1, wherein generation of the signal related to tire pressure is carried out when the pressure of the tire drops below a predetermined value.

3. The method as recited in claim 1, wherein generation of the signal related to tire pressure is carried out when the drop in pressure per unit of time exceeds a predetermined value.

4. The method as recited in claim 2, wherein generation of the signal related to tire pressure is generated by an air pressure sensor.

5. The method as recited in claim 2, wherein the detection of an abnormal drop in tire pressure is carried out after a first indication from an air pressure sensor and a second indication from at least one additional sensor related to the air pressure in at least one of the tires on the vehicle.

6. The method as recited in claim 2, wherein the detection of an abnormal drop in tire pressure is carried out after a first indication from at least one sensor related to the air pressure in one or several tires and a second indication from an air pressure sensor.

7. The method as recited in claim 1, wherein the braking function for other braking devices on the vehicle is controlled to compensate for the loss of braking function associated with the reduction in braking function associated with the axle on which the tire is mounted that has been detected as experiencing an abnormal pressure drop.

8. The method as recited in claim 7, wherein the control unit is configured to select a control program for regulating the other braking devices in response to which axle has had braking function associated therewith reduced.

9. The method as recited in claim 1, further comprising
gradually restoring the braking function to the braking devices for which the braking function has been reduced.

10. An arrangement for controlling the driving brakes of a vehicle or a vehicle combination comprising at least two wheel axles, each axle having two or more wheels with tires, said arrangement comprising:
a control unit (1, 21) that controls the driving brakes and means for generating a signal proportional to the air pressure in at least one tire, said control unit (1,21) being configured, upon the reception of said signal, to detect whether there has been an abnormal drop in tire pressure; and
said control unit (1, 21) being further configured to reduce the braking function of braking devices (6, 7; 8, 9; 26, 27; 28, 29) associated with the axle (10, 11; 30, 31) with which the tire experiencing an abnormal drop in pressure is associated.

11. The arrangement as recited in claim 10, wherein the control unit (1, 21) is provided with a plurality of control programs for regulating the braking devices (6, 7; 8, 9; 26, 27; 28, 29) and is configured to select a particular control program in response identification of the axle on which a drop in tire pressure has been detected.

12. The arrangement as recited in claim 10, wherein the control unit (1, 21) is configured to control other braking devices (6, 7; 8, 9; 26, 27; 28, 29) of the vehicle in such a way that a braking force required by the driver is delivered by compensating for the loss of braking function on the one axle by increasing the braking function on another axle (10, 11; 30, 31).

13. The arrangement as recited in claim 10, wherein the control unit (1, 21) is arranged to restore the braking function gradually after a predetermined period of time to the braking devices (6, 7; 8, 9; 26, 2; 28, 29) for which the braking function has been reduced.

14. The arrangement as recited in claim 10, wherein said means for detecting a drop in pressure comprises a pressure sensor (2, 3, 4, 5) and said control unit (1, 21) is configured to reduce the braking function if the pressure in a tire drops below a predetermined value.

15. The arrangement as recited in claim 10, wherein said means for detecting a drop in pressure comprises a pressure sensor (2, 3, 4, 5) and at least one additional sensor and said control unit (1, 21) is configured to reduce the braking function when both the pressure sensor and said additional sensor indicate that the pressure in a tire drops below a predetermined value.

16. The arrangement as recited in claim 15, wherein said additional sensors for detecting a drop in pressure comprise wheel speed sensors (22, 23, 24, 25) and said control unit (1, 21) is configured to reduce the braking function when a detected difference in speed between two wheels on the same axle (30, 31) exceeds a predetermined value.

17. The arrangement as recited in claim 15, wherein said additional sensors for detecting a drop in pressure consist of level sensors (32, 33, 34, 35) in the vehicle's hydraulic suspension and said control unit (1, 21) is configured to reduce the braking function when at least one of the level sensors indicates that a sudden axle inclination exceeds a predetermined value.

18. The arrangement as recited in claim 15, wherein said additional sensors for detecting a drop in pressure consist of pressure sensors (32, 33, 34, 35) in the vehicle's hydraulic suspension and said control unit (1, 21) is configured to reduce the braking function when at least one of the pressure sensors indicates that a sudden axle inclination exceeds a predetermined value.

19. The arrangement as recited in claim 15, wherein in said additional sensor for detecting a drop in pressure comprises a swerve speed sensor (41) for detecting swerve speed and said control unit (1, 21) is configured to reduce the braking function when the swerve speed suddenly exceeds a predetermined value.

20. The arrangement as recited in claim 19, wherein the swerve speed sensor comprises a gyro sensor.

21. The arrangement as recited in claim 15, wherein said additional sensor for detecting a drop in pressure comprises an acceleration sensor (41) for detecting lateral acceleration and said control unit (1, 21) is configured to reduce the braking function when the lateral acceleration suddenly exceeds a predetermined value.

22. The arrangement as recited in claim 15, wherein said additional sensor for detecting a drop in pressure comprises at least one microphone for detecting a tire bursting and said control unit (1, 21) is configured to reduce the braking function when an output signal from the microphone suddenly exceeds a predetermined value.
